(19) United States
(12) Patent Application Publication
(10) Pub. No.: US 2015/0022862 A1
(43) Pub. Date: Jan. 22, 2015

(54) PRINTING APPARATUS, PRINTING METHOD, AND RECORDING MEDIUM

(71) Applicant: SHARP KABUSHIKI KAISHA, Osaka-shi, Osaka (JP)

(72) Inventor: Hiroyuki Ataka, Osaka-shi (JP)

(21) Appl. No.: 14/377,637

(22) PCT Filed: Feb. 5, 2013
(86) PCT No.: PCT/JP2013/052600

§ 371 Date: Aug. 8, 2014

(30) Foreign Application Priority Data
Feb. 28, 2012 (JP) 2012-042502

(51) Int. Cl. G06K 15/02; G06F 3/12

(52) U.S. Cl. CPC G06K 15/1886; G06F 3/1211; G06F 3/1248; G06K 15/1823
USPC 358/1.17

(57) ABSTRACT

At the printing of a first set of copies, image data of a page that requires a long development time is preferentially stored in an image data storage section (S6 to S10). This makes it possible to curb a decrease in printing speed.

### TECHNICAL FIELD

The present invention relates to a printing apparatus, having an electronic sorting function, which prints an image corresponding to print data received from an external apparatus.

### BACKGROUND ART

A printing system has been conventionally used in which a printing apparatus (image forming apparatus) such as a multifunction printer or a printer is connected via a LAN (Local Area Network) or the like network to an external apparatus such as a personal computer so that the printing apparatus performs printing based on print data transmitted from the external apparatus.

The printing system of this kind is generally arranged, in order to reduce the amount of communication data, such that data transmitted for printing from, the external apparatus to the printing apparatus is print data represented in a page description language (PDL), rather than image data in a bitmap format or the like format. Accordingly, the printing apparatus develops the print data received from the external apparatus into image data and then performs printing using the developed image data.

Now, some of the recent printing apparatuses include an electronic sorting function. The electronic sorting function is a function for, when images of multiple pages are to be printed in a plurality of sets of copies, printing collated sets of copies of the pages rather than printing multiple copies for each of the pages. That is, the electronic sorting function carries out printing in such a manner that all of the pages are printed in a first set of copies and then printed in a second set of copies.

In order to curb a printing speed decrease caused by a wait time for the completion of the development process of developing print data into image data, some of the printing apparatuses having the electronic sorting function are arranged to allow the image data obtained by development at the printing of a first set of copies to be stored in memory of the printing apparatus so that the image data stored in memory is used for the printing of a second or subsequent set of copies.

This arrangement, however, can cause the problem, for example, that when a large number of pages need to be printed in a plurality of sets of copies, a failure to store pieces of image data of all of the pages in the memory occurs due to a lack of available space in the memory. One solution to the problem is to provide a printing apparatus that has memory with a storage capacity large enough to store the pieces of image data of all of the pages to be printed, even when the pages are a large number of pages. This, however, results in an increased manufacturing cost of the printing apparatus.

As a technique for solving the above problem, Patent Literature 1 discloses the technique of making a comparison in data amount between print data transmitted from the external apparatus to the printing apparatus and image data obtained by developing that print data, and then determining, for each page, whether the print data or the image data is to be stored in memory of the printing apparatus, on the basis of a result of the comparison.

### CITATION LIST

### Patent Literatures

### Patent Literature 1

Japanese Patent Application Publication, Tokukai, No. 2002-132465 (Publication Date: May 10, 2002)

### SUMMARY OF INVENTION

### Technical Problem

The technique disclosed in Patent Literature 1 always saves either the print data or the image data, for each page. This, unfortunately, causes the following problem. That is, a lack of available space in the memory of the printing apparatus leads to a failure to store pieces of data (print data or image data) of a current page and its subsequent page(s), which disables the electronic sorting function.

Furthermore, a time required for the process of developing print data into image data is not always proportional to the amount of data. For example, the time required for the development can be increased even when the data amount of the print data is smaller than that of the image data. Consequently, the technique disclosed in Patent Literature 1 may inadequately reduce a printing time for a second or subsequent set of copies.

The present invention has been attained in view of the above problem, and an object of the present invention is to provide a printing apparatus, having an electronic sorting function, which curbs a printing speed decrease caused by a wait time for the completion of the development process of developing print data into image data.

### Solution to Problem

A printing apparatus in accordance with one embodiment of the present invention is a printing apparatus having an electronic sorting function for carrying out, when images of multiple pages are to be printed in a plurality of sets of copies, a printing process of printing each set of copies in collated form, the printing apparatus including: a communication section to carry out communication with an external apparatus; a development process section to carry out a development process of developing print data received by the communication section from the external apparatus into image data, a printing process section to carry out a printing process based on the image data; a development time measuring section to measure a time required to complete the development process for each of the pages, an image data storage section to store the image data therein; and a control section to control respective operations of the foregoing sections, in order for said printing apparatus to perform printing using the electronic sorting function, the control section operating at printing of a first set of copies to cause the image data storage section to preferentially store image data of a page that requires a long development time, and the control section operating at printing of a second or subsequent set of copies to cause the printing process section to perform a printing process so that printing of a page whose image data is stored in the image data storage section is carried out using that image data, while, for printing of another page whose image data is not stored in the image data storage section, the control section causing the communication section to obtain print data of that page from the external apparatus, and then causing the development process section to subject the obtained print data to the development process to generate image data, so that the printing apparatus performs printing based on the generated image data.

### Advantageous Effects of Invention

The printing apparatus in accordance with one embodiment of the present invention can carry out a quick printing process, when performing printing using the electronic sorting function, by preventing a printing process delay caused by a wait time for the completion of the development process of developing print data into image data.

### BRIEF DESCRIPTION OF DRAWINGS

FIG. 1 is a flowchart illustrating example processes in an image formation system in accordance with one embodiment of the present invention.

FIG. 2 is a view illustrating the configuration of the in accordance with the embodiment of the present invention.

FIG. 3 is a view illustrating the structure of page data saved in an image forming apparatus, which is provided in the image formation system illustrated in FIG. 2.

FIG. 4 is a flowchart illustrating another example processes in the image formation system illustrated in FIG. 2.

FIG. 5 is a flowchart illustrating still another example processes in the image formation system illustrated in FIG. 2.

### DESCRIPTION OF EMBODIMENTS

The following will describe one embodiment of the present invention.

(1-1. Configuration of Image Formation System 1)

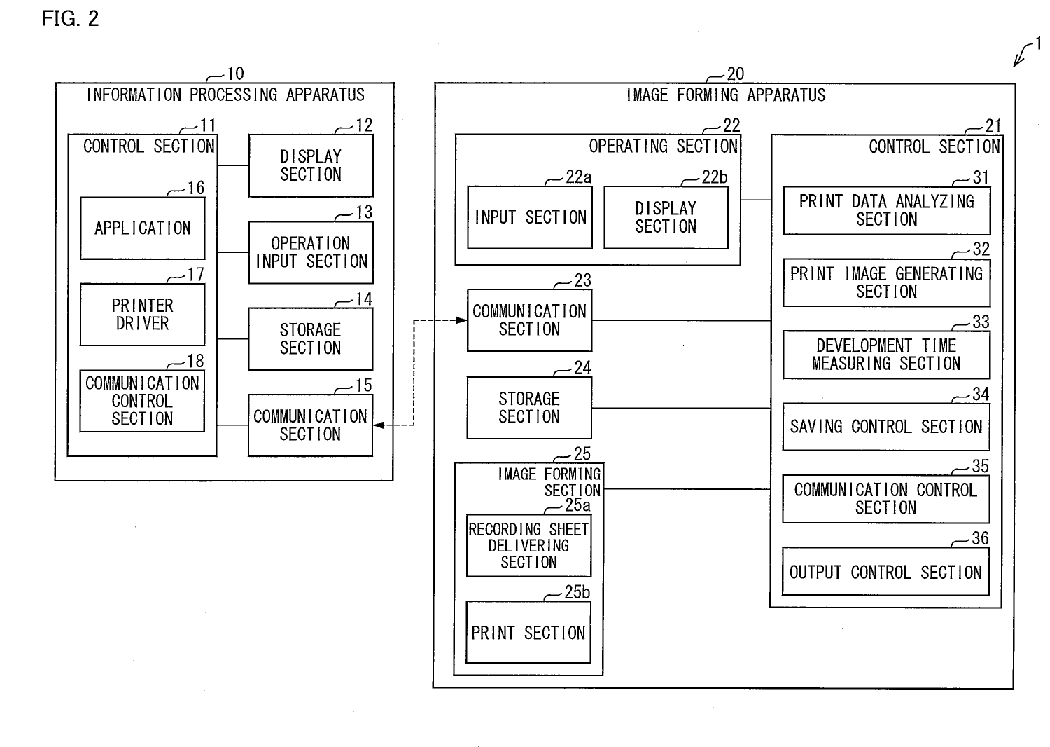

FIG. 2 is a view illustrating the configuration of an image formation system 1 in accordance with an embodiment of the present invention. As illustrated in FIG. 2, the image formation system 1 includes an information processing apparatus (external apparatus) 10 and an image forming apparatus (printing apparatus) 20, which are intercommunicatively connected to each other.

The information processing apparatus 10 includes: a control section 11; a display section 12; an operation input section 13; a storage section 14; and a communication section 15. Note that the information processing apparatus can be, for example, a personal computer, a workstation, or the like.

The control section 11 is a computer device including: a computing section (not illustrated) such as a CPU or a special-purpose processor; and a storage section (not illustrated) such as RAM, ROM, or HDD. The control section 11 reads and executes various kinds of information and programs for carrying out various kinds of controls, wherein the information and the programs are stored in the storage section, thereby implementing respective functions of an application 16, a printer driver 17, and a communication control section 18.

The application 16 is application software for generating various kinds of data in response to instructions provided by a user. The type of the application 16 is not particularly limited to any specific one, and examples of the application 16 include a word processing software, a spreadsheet software, an image processing software, a graphics drawing software, a CAD (computer aided design) software, an image filing software, an e-mail software, and a web-browser software.

The printer driver 17, in response to an instruction provided by a user, generates print data to be transmitted to the image forming apparatus 20. Note that in the present embodiment, the printer driver 17 generates, as the print data, data in page description language (PDL).

The communication control section 18 controls an operation of the communication section 15 so that the communication section 15 carries out communications with the image forming apparatus 20. For example, the communication control section 18 controls the communication section 15 to perform processing to transmit print data generated by the printer driver 17 to the image forming apparatus 20, processing to receive a data transmission request transmitted from the image forming apparatus 20 and then transmit, to the image forming apparatus 20, data corresponding to the data transmission request, and other processes.

The display section 12 is display means for displaying an image corresponding to an instruction provided by the control section 11. The structure of the display section 12 is not particularly limited to any specific one, and examples of the display section 12 include a liquid crystal display, a plasma display, an organic EL display, and a CRT (cathode ray tube) display.

The operation input section 13 intends to receive an instruction entered by a user and then transfer that instruction to the control section 11. The structure of the operation input section 13 is not particularly limited to any specific one, and examples of the operation input section 13 include a keyboard, a mouse, and a stylus input device.

The storage section 14 is storage means for storing various kinds of data therein in response to an instruction provided by the control section 11. The structure of the storage section 14 is not particularly limited to any specific one, and examples of the storage section 14 include: a non-volatile memory such as HDD or FLASH memory; and a volatile memory such as RAM.

The communication section 15 is a communication interface to carry out communications with the image forming apparatus 20. A scheme of communications carried out by the communication section 15 is not particularly limited. For example, the communication section 15 can be configured to carry out communications via a communication network such as a LAN (Local Area Network), to carry out communications through a parallel interface, USB-based communications, or the like wired communications, or to carry out infrared communications, Bluetooth®-based communications, 802.11 wireless communications, or the like wireless communications.

The image forming apparatus 20 prints, onto a recording sheet, an image corresponding to print data received from the information processing apparatus 10. The image forming apparatus 20 includes a control section 21, an operating section 22, a communication section 23, a storage section (image data storage section) 24, and an image forming section (printing process section) 25.

The operating section 22 is a user interface to notify a user of various information items and to accept an entry made by the user, and the operating section 22 includes: an input section (operation input section) 22a including various input keys; and a display section 22b constituted by a LCD (Liquid Crystal Display) or the like. The structures of the input section 22a and the display section 22b are not particularly limited to any specific ones. For example, the input section 22a and the display section 22b may be integrated into a touch panel.

The communication section 23 is a communication interface to carry out communications with the information processing apparatus 10. As described earlier, a scheme of communications carried out between the information processing apparatus 10 and the image forming apparatus 20 is not particularly limited. For example, the communication section 23 can be configured to carry out communications via a communication network such as a LAN (Local Area Network), to carry out wired communications through a parallel interface, to carry out IEEE 1394-based communications, USB-based communications, or the like wired communications, or to carry out infrared communications, Bluetooth®-based communications, 802.11 wireless communications, or the like wireless communications.

The storage section 24 is storage means for storing various kinds of data therein in response to an instruction provided by the control section 21. The structure of the storage section 24 is not particularly limited to any specific one, and examples of the storage section 24 include: a non-volatile memory such as HDD or FLASH memory; and a volatile memory such as RAM.

The image forming section 25 includes: a recording sheet delivering section 25a to deliver a recording sheet; and a print section 25b to form an image corresponding to image data on a recording sheet delivered by the recording sheet delivering section 25a. The structure of the image forming section 25 is not particularly limited to any specific one, and the image forming section 25 can be, for example, an electrophotographic printer, an ink-jet printer, or the like printer.

The control section 21 is a computer device including: a computing section (not illustrated) such as a CPU or a special-purpose processor; and a storage section (not illustrated) such as RAM, ROM, or HDD. The control section 21 controls respective operations of the individual sections provided in the image forming apparatus 20, by reading and executing various kinds of information and programs for carrying out various kinds of controls, wherein the information and the programs are stored in the storage section.

Specifically, the control section 21 includes a print data analyzing section 31, a print image generating section (development process section) 32, a development time measuring section 33, a saving control section 34, a communication control section 35, and an output control section 36.

The print data analyzing section 31 analyzes print data received from the information processing apparatus 10, to obtain various kinds of setting information including a size and/or type of a recording sheet (or a designated paper feeding tray), a print count (the number of copies to be printed), whether or not two-sided printing is needed, whether or not an electronic sorting function is needed, and a tray to which a print sheet is to be ejected (a designated paper output tray).

The print image generating section 32 develops print data represented in page description language, which print data is received from the information processing apparatus 10, to generate print image (graphical data) represented in a bit-map format or the like format.

The development time measuring section 33 measures, for each of pages, a time required for the print image generating section 32 to complete the development process of developing print data of the page into print image.

The saving control section 34 controls writing (saving) of data to the storage section 24 and reading of data from the storage section 24.

In the present embodiment, when printing is performed using the electronic sorting function, the saving control section 34 causes the storage section 24 to store therein print image generated by the print image generating section 32. During the storage of the print image by the storage section 24, in a case where print images of all the pages cannot be saved in the storage section 24 due to an insufficient storage space in the storage section 24, print image of a page that requires a long development time is preferentially stored in the storage section 24, while print image(s) of the remaining page(s) are not stored in the storage section 24. As to the remaining page(s), their corresponding print data are obtained from the information processing apparatus 10 at the printing of a second or subsequent copy of the pages. How the electronic sorting function works will be described in detail later.

The communication control section (host notification processing section) 35 controls the operation of the communication section 23 so that the communication section 23 carries out communications with the information processing apparatus 10. For example, the communication control section 35 controls the communication section 23 to perform processing to receive print data transmitted from the information processing apparatus 10, processing to transmit, to the information processing apparatus 10, a data transmission request in response to an instruction from the control section 21, and processing to transmit status information of the image forming apparatus 20 to the information processing apparatus 10.

The output control section 36 controls the operation of the image forming section 25 so that the image forming section 25 forms, on a recording sheet, an image corresponding to image data generated by the print image generating section 32.

(1-2. Printing Process Using Electronic Sorting Function)

Next, the following will describe the operations carried out when printing is performed using the electronic sorting function. Note that the electronic sorting function is a function for carrying out, when images of multiple pages are to be printed in a plurality of sets of copies, a printing process of printing each set of copies in collated form, i.e., a function for, when images of multiple pages are to be printed in a plurality of sets of copies, printing collated sets of copies of the pages rather than printing multiple copies for each of the pages.

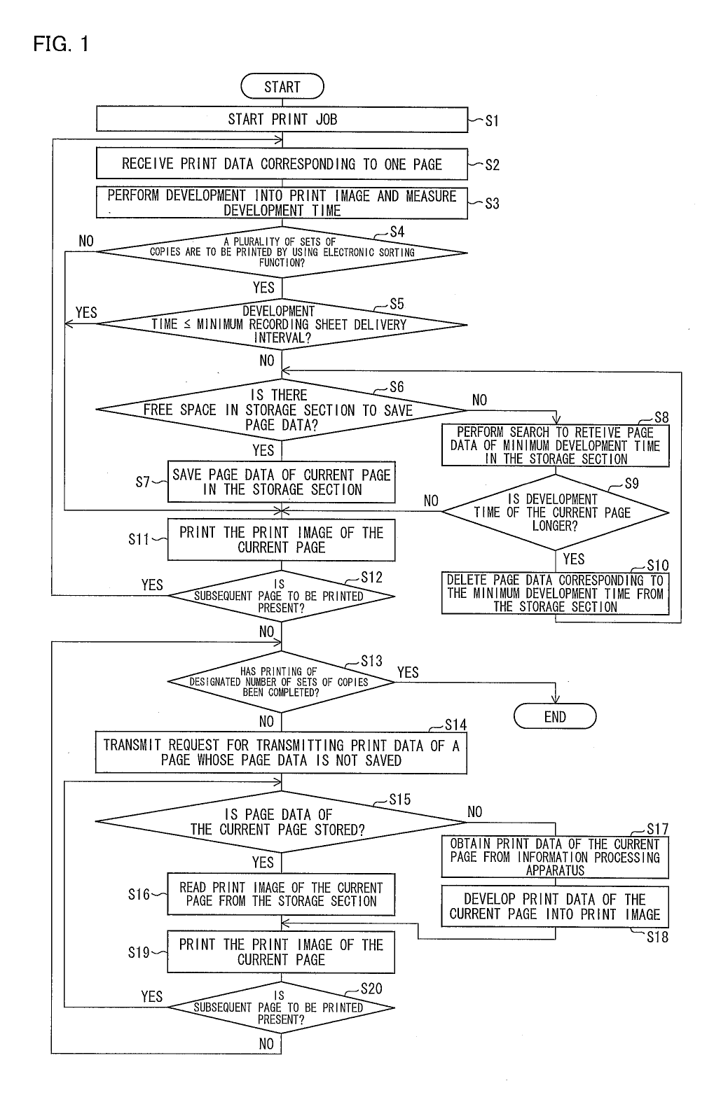

FIG. 1 is a flowchart illustrating the flow of processes carried out when printing is performed using the electronic sorting function.

Upon receipt of a print job start request from the information processing apparatus 10, the control section 21 of the image forming apparatus 20 starts a print job (S1).

Further, the control section 21 receives print data corresponding to one (1) page (S2) and then (i) causes the print image generating section 32 to develop the received print data into a print image and (ii) causes the development time measuring section 33 to measure a time required for that development process (S3).

Subsequently, the control section 21 causes the print data analyzing section 31 to analyze reception data received from the information processing apparatus 10 to determine whether or not a plurality of sets of copies are to be printed by using the electronic sorting function (S4).

In S4, in a case where the print data analyzing section 31 determines that there is no need to use the electronic sorting function or that only a single set of copies needs to be printed, the control section 21 causes the output control section 36 to control the respective operations of the individual sections provided in the image forming section 25, so that an image corresponding to the print image of the current page is printed on a recording sheet (S11). That is, in the present embodiment, in a case where a single set of copies needs to be printed, saving of a print image, which is generated by the development process with respect to print data, to the storage section 24 is not performed.

On the other hand, in S4, in a case where the print data analyzing section 31 determines that a plurality of sets of copies need to be printed by using the electronic sorting function, the control section 21 determines whether or not the length of the development time for the current page (time required for the development process) is not more than that of the minimum recording sheet delivery interval (S5). Note that the minimum recording sheet delivery interval is a time interval between sequential deliveries of recording sheets when they are delivered so that printing is performed in a maximum output count for each unit time by the image forming apparatus 20, i.e., a time interval between sequential deliveries of recording sheets under the circumstances where a wait time for delivery of a recording sheet due to a cause such as a wait for preparation of a print image does not occur.

In S5, in a case where the control section 21 determines that the length of the development time for the current page is not more than that of the minimum recording sheet delivery interval, the control section 21 causes the output control section 36 to control the respective operations of the individual sections provided in the image forming section 25 so that an image corresponding to the print image of the current page is printed on a recording sheet (S11). In this manner, in a case where the development time is not more than the minimum recording sheet delivery interval, the process of printing the print image is carried out, but the process of saving the print image is not carried out.

On the other hand, in S5, in a case where the control section 21 determines that the length of the development time for the current page is more than that of the minimum recording sheet delivery interval, the control section 21 causes the saving control section 34 to determine whether or not the storage section 24 has a free space to save page data containing the print image of the current page (S6).

Then, in a case where the saving control section 34 determines that the storage section 24 has a free space to save the page data of the current page, the control section 21 causes the storage section 24 to save therein the page data of the current page (S7) and then causes the output control section 36 to control the respective operations of the individual sections provided in the image forming section 25 so that the image corresponding to the print image of the current page is printed on a recording sheet (S11).

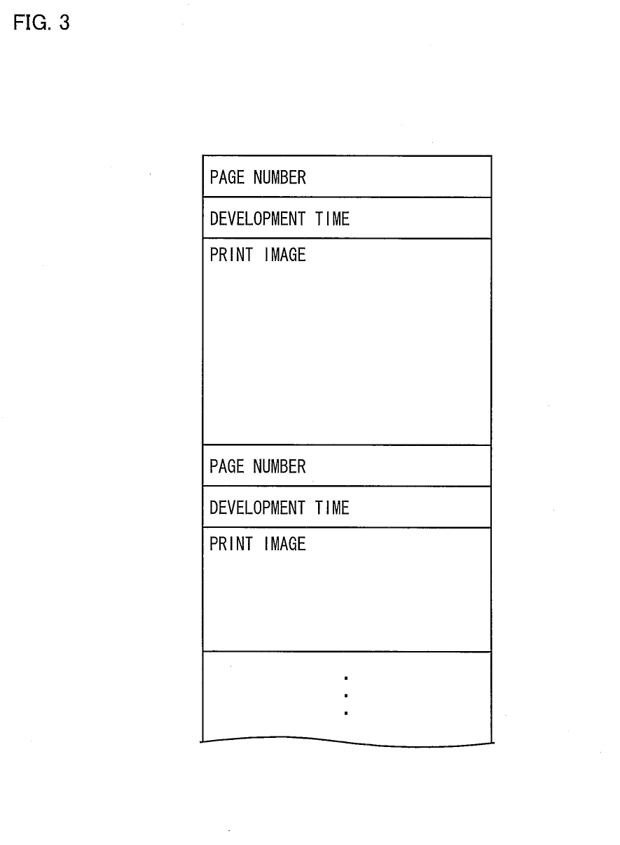

FIG. 3 is a view illustrating the structure of the page data saved in the storage section 24. As illustrated in FIG. 3, the present embodiment is arranged to cause the storage section 24 to store therein a page-data saving table containing respective pieces of page data of a plurality of pages. Further, page data contains, for each page, a page number, a development time, and a print image.

On the other hand, in S6, in a case where the saving control section 34 determines that the storage section 24 does not have a free space to save the page data of the current page, the control section 21 causes the saving control section 34 to search, for page data requiring a shortest development time (minimum development time), respective pieces of page data of individual pages, which pieces of page data are saved in the storage section 24, and retrieve that minimum development time (S8).

Then, the control section 21 causes the saving control section 34 to determine whether the length of the development time for the current page is more than that of the minimum development time retrieved in S8 (S9).

In S9, in a case where the length of the development time for the current page is equal to or less than that of the minimum development time, the control section 21 causes the output control section 36 to control the respective operations of the individual sections provided in the image forming section 25 so that the image corresponding to the print image of the current page is printed on a recording sheet (S11).

On the other hand, in S9, in a case where the saving control section 34 determines that the length of the development time for the current page is more than that of the minimum development time, the control section 21 causes the saving control section 34 to delete the page data corresponding to the minimum development time stored in the storage section 24 (S10) and then returns to the process in S6. In this manner, page data of a page requiring a long development time is preferentially stored in the storage section 24.

After the current page is printed in S11, the control section 21 determines whether or not a subsequent page to be printed is present, i.e., whether or not printing of a first set of copies for all the pages has been completed (S12). In a case where the control section 21 determines that a subsequent page to be printed is present, the control section 21 returns to S2 and then carries out the processes for the subsequent page.

On the other hand, in S12, in a case where the control section 21 determines that no subsequent page to be printed is present, i.e., that printing of a first set of copies for all the pages has been completed, the control section 21 determines whether or not printing of a designated number of sets of copies has been completed (S13). In a case where the control section 21 determines that printing of the designated number of sets of copies has been completed, the control section 21 finishes the printing process and then waits for an arrival of a subsequent print job start request.

On the other hand, in S13, in a case where the control section 21 determines that printing of the designated number of sets of copies has not been completed yet, the control section 21 transmits, to the information processing apparatus 10, a request for transmitting print data of a page whose page data is not saved in the storage section 24 (S14). Specifically, the control section 21 causes the saving control section 34 to make a search for a page whose page data is not saved in the storage section 24, and the control section 21 then causes the communication control section 35 to control the communication section 23 so that the communication section 23 transmits, to the information processing apparatus 10, a request for transmitting print data of that page whose page data is not saved in the storage section 24.

Thereafter, the control section 21 causes the saving control section 34 to determine whether or not the page data of the current page is stored in the storage section 24 (S15).

In a case where the saving control section 34 determines that the page data of the current page is stored in the storage section 24, the control section 21 causes the saving control section 34 to read print image contained in the page data of the current page from the storage section 24 (S16), the control section 21 then causes the output control section 36 to control the respective operations of the sections provided in the image forming section 25 so that an image corresponding to the print image of the current page is printed on a recording sheet (S19).

On the other hand, in a case where the saving control section 34 determines that the page data of the current page is not stored in the storage section 24, the control section 21 obtains, through the communication section 23, the print data of the current page from the information processing apparatus 10 (S17), and causes the print image generating section 32 to develop the received print data into a print image (S18), and then causes the output control section 36 to control the respective operations of the individual sections provided in the image forming section 25 so that the image corresponding to the print image of the current page is printed on a recording sheet (S19).

After the current page is printed in S19, the control section 21 determines whether or not a subsequent page to be printed is present, i.e., whether or not printing of the set of copies currently being processed for all the pages has been completed (S20). In a case where the control section 21 determines that a subsequent page to be printed is present, the control section 21 returns to S15 and then carries out the processes for the subsequent page. In a case where the control section 21 determines that no subsequent page to be printed is present, the control section 21 returns to the process in S13.

As described above, the image formation system 1 in accordance with the present embodiment is arranged such that, in a case where the printing process using the electronic sorting function is to be carried out, the control section 21 of the image forming apparatus 20 causes the storage section 24 to preferentially store therein a print image of a page that requires a long time for the development of its corresponding print data into that print image. Then, a printing process for a second or subsequent set of copies is carried out as follows. That is, for a page which requires a long development time, its corresponding print image obtained by the development and stored in the storage section 24 is used for printing. On the other hand, for a page which requires a short development time, its corresponding print data is obtained again for printing from the information processing apparatus 10.

This makes it possible to reduce a wait time for the completion of the printing process, which wait time caused by the development process, at the printing of a second or subsequent set of copies, thus enabling the printing process to be carried out quickly. Note that since the print data of the page that requires a short development time can be transmitted in a relatively short time from the information processing apparatus to the image forming apparatus, it is also possible to prevent a wait time for the completion of the printing process from occurring due to transmission and/or reception of the print data.

The present embodiment is arranged such that a request for transmitting a group of the piece(s) of print data of the respective page(s) whose page data are not stored in the storage section 24, is made in S14. However, this arrangement is not the only possibility. For example, a request for transmitting page data of the current page may be made in S15, not in S14, when it is determined in S15 that the page data of the current page is not stored in the storage section 24,

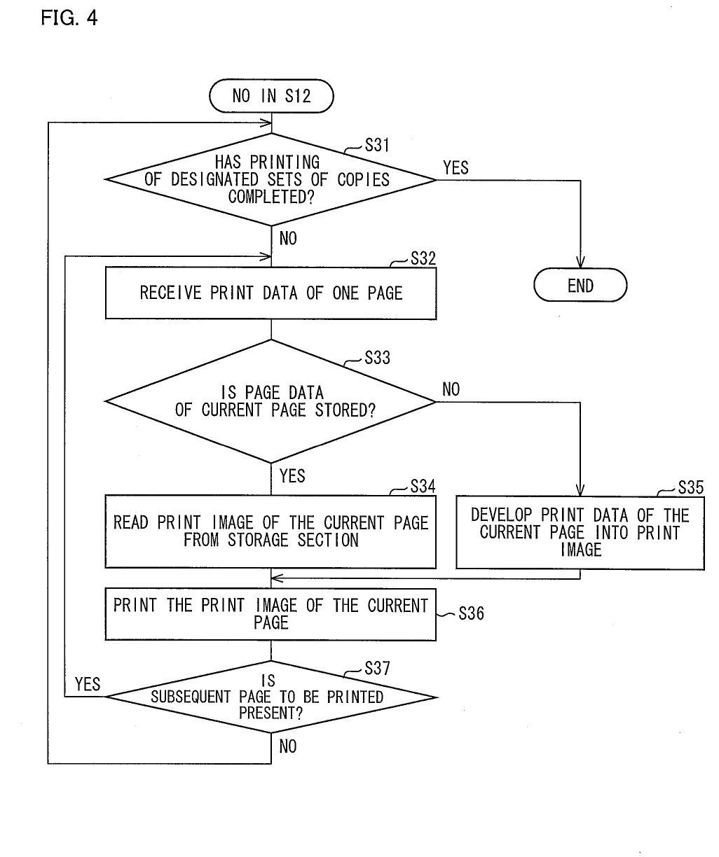

Alternatively, the present embodiment may be arranged such that, at the printing of a second or subsequent set of copies, the information processing apparatus 10 re-transmits pieces of print data of all the pages, regardless of whether or not the page data is stored in the storage section 24. FIG. 4 is a flowchart illustrating the flow of the processes carried out for that arrangement. Note that processes in S31 to S37 in FIG. 4, are carried out instead of the processes in S13 to S20 (the process for printing a second or subsequent set of copies) in FIG. 1.

As illustrated in FIG. 4, in a case where it is determined in S12 that no subsequent page to be printed is present, the control section 21 determines whether or not printing of a designated number of sets of copies has been completed, the control section 21 finishes the printing process and waits for an arrival of a subsequent print job start request.

On the other hand, in a case where it is determined in S31 that printing of a designated number of sets of copies has not been completed yet, the control section 21 receives print data of one (1) page from the information processing apparatus 10 (S32). The control section 11 (printer driver 17) of the information processing apparatus 10 sequentially transmits pieces of print data of all the pages even at the printing of a second or subsequent set of copies, regardless of whether or not their respective print images are stored in the storage section 24 of the image forming apparatus 20, in the same manner that the control section 11 does at the printing of the first set of copies.

Subsequently, the control section 21 causes the saving control section 34 to determine whether or not page data of a current page is stored in the storage section 24 (S33).

Then, in a case where the saving control section 34 determines that the page data of the current page is stored in the storage section 24, the control section 21 causes the saving control section 34 to read print image contained in the page data of the current page from the storage section 24 (S34), and the control section 21 causes the output control section 36 to control the respective operations of the individual sections provided in the image forming section 25 so that an image corresponding to the print image of the current page is printed on a recording sheet (S36). In this case, the received print data of that current page from the information processing apparatus 10 is discarded.

On the other hand, in a case where the saving control section 34 determines that the page data of the current page is not stored in the storage section 24, the control section 21 causes the print image generating section 32 to develop the print data of the current page obtained from the information processing apparatus 10 into its corresponding print image (S35), and causes the output control section 36 to control the respective operations of the individual sections provided in the image forming section 25 so that an image corresponding to the print image of the current page is printed on a recording sheet (S36).

After the current page is printed in S36, the control section 21 determines whether or not a subsequent page to be printed is present, i.e., whether or not printing of the set of copies currently being processed for all the pages has been completed (S37). In a case where the control section 21 determines that a subsequent page to be printed is present, the control section 21 returns to S32 and then carries out the processes for the subsequent page. In a case where the control section 21 determines that no subsequent page to be printed is present, the control section 21 returns to the process in S31.

As illustrated in FIG. 1, the image forming apparatus 20 transmits a request for transmitting print data of a page whose print image is not stored in the storage section 24. On the other hand, as illustrated in FIG. 4, the information processing apparatus 10 retransmits pieces of print data of all the pages regardless of whether or not page data of interest is stored in the storage section 24. For example, a choice between the transmission of the print data transmission request in FIG. 1 and the print data retransmission in FIG. 4 may be determined by the user, as the user desires, through the operation input section 13 of the information processing apparatus 10 or through the input section. 22a of the image forming apparatus 20, or one of the transmission of the print data transmission request in FIG. 1 and the print data retransmission in FIG. 4 may be preset.

Further, the method illustrated in FIG. 4 is arranged such that, at the printing of a second or subsequent set of copies, printing of the page whose print image is stored in the storage section 24 is always made with use of that print image stored in the storage section 24. However, this arrangement is not the only possibility. As an alternative example, the following arrangement may be adopted. That is, in a case where the image forming section 25 undergoes calibration for updating density correction information, the control section 21 determines whether or not a re-development process based on the updated density correction information needs to be carried out for the print data. In a case where the control section 21 determines that the re-development process needs to be carried out, the print data retransmitted from the information processing apparatus 10 may be subjected to the re-development process according to output characteristics of the image forming section 25, before subjected to printing, even when the corresponding page data is stored in the storage section 24.

Note that the print image generating section 32 is arranged to perform, in subjecting print data to the development process to generate its corresponding print image, the image forming section 25 carries out the development process based on density correction information that is generated by the image forming section 25 according to output characteristics of the image forming section 25. That is, the print image generating section 32 generates the print image from the print data whose density information has been corrected based on the density correction information.

Further, the image forming section 25 includes: an output characteristics detecting section (not illustrated) to detect output characteristics of the image forming section 25; and a calibration processing section (not illustrated) to carry out calibration for updating density correction information according to a result of detection made by the output characteristics detecting section. Note that a method of detecting output characteristics is not particularly limited to any specific one and can be a previously known method. For example, a pattern for determination of output characteristics (color reproduction characteristics) may be formed on a recording sheet, an intermediate transfer member, a photoreceptor, or other member, so that detection of the output characteristics can be made by scanning of the formed pattern by a sensor or the like device. A calibration method is not particularly limited to any specific one, and may be a previously known method.

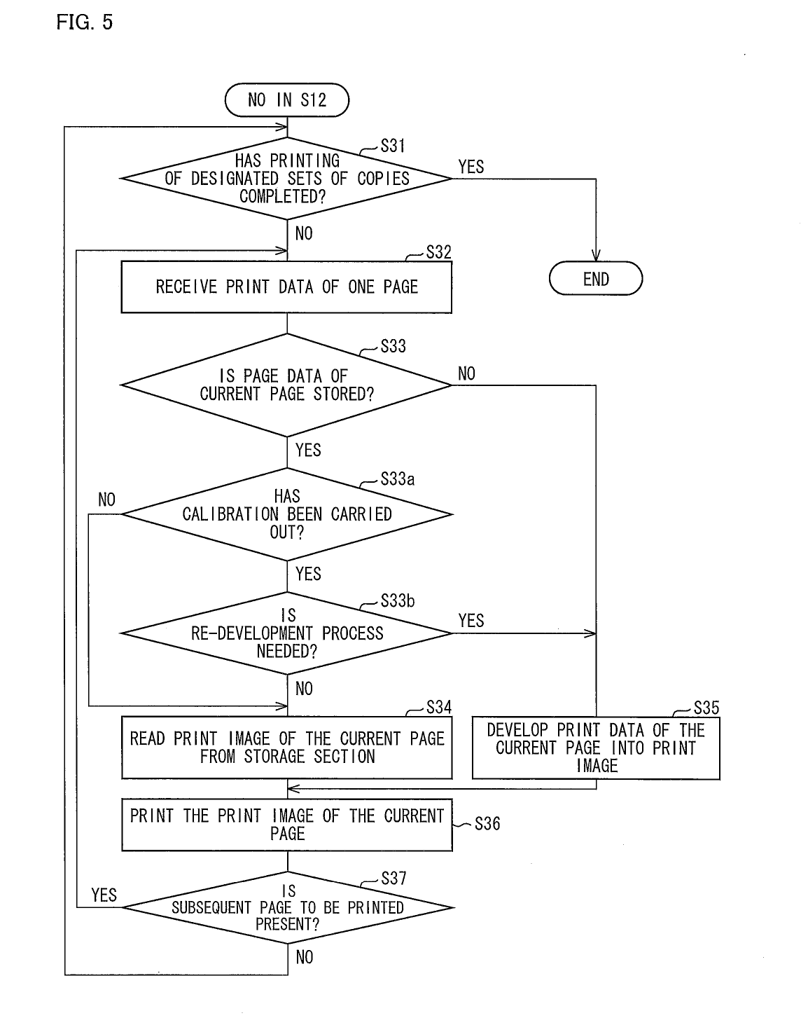

FIG. 5 is a flowchart illustrating the flow of the processes carried out when it is determined whether or not print data is to be subjected to the re-development process based on the density correction information updated by the calibration. The processes illustrated in FIG. 5 are identical to those illustrated in FIG. 4, except that, after it is determined in S33 that the print image is stored in the storage section 24, the processes in S33a and S33b are carried out prior to the process in S34. As such, the description of the commonality between the processes illustrated in FIGS. 4 and 5 are omitted here.

After it is determined in S33 that the print image is stored in the storage section 24, the control section 21 determines whether or not calibration has been carried out by the image forming section 25 after that print image was stored in the storage section 24 (S33a).

In a case where it is determined in S33a that calibration has not been carried out, the control section 21 proceeds to S34 to carry out the printing process using the print image stored in the storage section 24.

On the other hand, in a case where it is determined in S33a that calibration has been carried out, the control section 21 determines whether or not the re-development process based on the density correction information updated by the calibration needs to be carried out for print data (S33b).

For example, the control section 21 determines that the re-development process is needed for halftone-containing print image stored in the storage section 24, whereas determining that no re-development process needs to be carried out for halftone-free print image stored in the storage section 24. That is, the density correction information updated when the calibration is done is reflected by halftoning process, i.e., dithering process. Hence, change of the density correction information has an influence on a print image containing halftones, but has no influence on a print image containing no halftones. Consequently, the control section 21 determines that the re-development process needs to be carried out for halftone-containing print image stored in the storage section 24, whereas determining that no re-development process needs to be carried out for halftone-free print image stored in the storage section 24.

In a case where it is determined in S33b that re-development is needed, the control section 21 proceeds to S35 to carry out the printing process using the print image stored in the storage section 24.

In this manner, it is possible to appropriately carry out the printing process of printing each set of copies, in response to a change in output characteristics of the image forming section 25.

Note that although FIG. 5 illustrates that the process of detecting output characteristics of the image forming section 25 is carried out in S33a, this is not the only possible example. Alternatively, the detection process may be carried out every time a predetermined number of copies are printed. Further alternatively, the detection process may be carried out every time the printing process of printing a set of copies is completed.

In the above embodiment, the sections (blocks), in particular, the control sections 11 and 21; provided in the information processing apparatus 10 and the image forming apparatus 20 may be realized by software as executed by a processor such as a CPU (Central Processing Unit). In this case, the information processing apparatus 10 and the image forming apparatus 20 each include a CPU that executes the instructions of a control program for realizing the aforesaid functions, ROM (Read Only Memory) that stores the control program, RAM (Random Access Memory) that develops the control program in executable form, and a storage device (storage medium), such as memory, that stores the control program and various types of data therein. With this arrangement, the object of the present invention is achieved by a computer (alternatively CPU or MPU) reading and executing the program stored in the storage medium. The storage medium stores, in computer-readable manner, program codes (executable code program, intermediate code program, and source program) of the control program of each of the information processing apparatus 10 and the image forming apparatus 20, which program is software for realizing the aforesaid functions. The storage medium is provided to the information processing apparatus 10 and the image forming apparatus 20.

The storage medium may be, for example, a tape, such as a magnetic tape and a cassette tape; a disk such as a magnetic disk including a Floppy® disk and a hard disk and an optical disk including CD-ROM, MO, MD, DVD, and CD-R; a card, such as an IC card (including a memory card) and an optical card; or a semiconductor memory, such as a mask ROM, EPROM, EEPROM®, and flash ROM.

Further, the information processing apparatus 10 and the image forming apparatus 20 may be arranged so as to be connectable to a communications network so that the program code is made available to the information processing apparatus 10 and the image forming apparatus through the communications network. The communications network is not to be particularly limited. Examples of the communications network include the Internet, intranet, extranet, LAN, ISDN, VAN, CATV communications network, virtual private network, telephone network, mobile communications network, and satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared light, Bluetooth®, 802.11, HDR, mobile phone network, satellite connections, and terrestrial digital network. Note that the present invention can be also realized by the program codes in the form of a computer data signal embedded in a carrier wave which is embodied by electronic transmission.

Alternatively, each of the blocks of the information processing apparatus 10 and the image forming apparatus 20 are not limited to the block that can be realized by software, and may be each constituted by hardware logic. As a further alternative example, each of the blocks of the information processing apparatus 10 and the image forming apparatus 20 may be a combination of hardware carrying out some of the processes and computing means controlling the hardware and executing software for the other processes.

As described above, a printing apparatus in accordance with one embodiment of the present invention is a printing apparatus having an electronic sorting function for carrying out, when images of multiple pages are to be printed in a plurality of sets of copies, a printing process of printing each set of copies in collated form, the printing apparatus including: a communication section to carry out communication with an external apparatus; a development process section to carry out a development process of developing print data received by the communication section from the external apparatus into image data, a printing process section to carry out a printing process based on the image data; a development time measuring section to measure a time required to complete the development process for each of the pages, an image data storage section to store the image data therein; and a control section to control respective operations of the foregoing sections, in order for said printing apparatus to perform printing using the electronic sorting function, the control section operating at printing of a first set of copies to cause the image data storage section to preferentially store image data of a page that requires a long development time, and the control section operating at printing of a second or subsequent set of copies to cause the printing process section to perform a printing process so that printing of a page whose image data is stored in the image data storage section is carried out using that image data, while, for printing of another page whose image data is not stored in the image data storage section, the control section causing the communication section to obtain print data of that page from the external apparatus, and then causing the development process section to subject the obtained print data to the development process to generate image data, so that the printing apparatus performs printing based on the generated image data.

According to the above arrangement, at the printing of a first set of copies, image data of a page that requires a long development time is preferentially stored in the image data storage section, which thus enables efficient printing of a second or subsequent set of copies. This makes it possible to prevent the occurrence of a printing process delay caused by a wait time for the completion of the development process of developing print data into image data, thus enabling a quick printing process.

Further, the printing apparatus may be arranged such that at the printing of the first set of copies during the printing performed using the electronic sorting function, the control section causes the image data storage section to sequentially store therein pieces of image data of pages, which image data are generated through the development process by the development process section, and, in an event that the image data storage section, as a result, has no enough free space to store image data of a subsequent page, the control section carries out a comparison, in length of time required to complete the development process, between that subsequent page and preceding pages whose image data are previously stored in the image data storage section to find, among the preceding pages whose image data are previously stored in the image data storage section, any page that requires a shorter development time than that subsequent page, and the control section then carries out a replacement process for deleting, from the image data storage section, image data of the page that requires a shorter development time than that subsequent page, and then letting the image data storage section store the image data of the subsequent page therein.

According to the above arrangement, at the printing of a first set of copies, image data of a page that requires a long development time is preferentially stored in the image data storage section.

Still further, the printing apparatus may be arranged such that at the printing of the second or subsequent set of copies during the printing performed using the electronic sorting function, the control section causes the communication section to transmit, to the external apparatus, a request for transmitting print data of a page whose image data is not stored in the image data storage section.

The printing apparatus may be arranged such that the printing process section includes: a recording sheet delivering section to deliver a recording sheet to be printed; and a print section to print images corresponding to pieces of image data on multiple recording sheets sequentially delivered by the recording sheet delivering section, and at the printing of the first set of copies during the printing performed using the electronic sorting function, the control section causes the image data storage section to avoid storing therein image data of a given page, out of the pages to be subjected to the printing process, if a length of time required to complete the development process for that given page is shorter than a minimum time interval between sequential deliveries of recording sheets by the recording sheet delivering section.

According to the above arrangement, as to a page meeting a condition such that a length of time required to complete the development process for that page is shorter than a minimum time interval between sequential deliveries of recording sheets by the recording sheet delivering section, i.e. a page not suffering from a printing process delay caused by a wait time for the completion of the development process, image data corresponding to that page is not stored in the image data storage section. Instead, print data of that page is obtained for use in printing, from the external apparatus, at the printing of a second or subsequent set of copies. This makes it possible to decrease the frequencies of performing the saving process and the replacement process with respect to the image data storage section.

Yet further, the printing apparatus may be arranged such that the printing apparatus has a single-copy printing function of printing an image of a single page or images of multiple pages in a single copy or a single set of copies, and the control section causes the image data storage section to store therein pieces of image data when printing of a plurality of sets of copies is to be performed using the electronic sorting function, while the control section causes the image data storage section to avoid storing therein a piece(s) of image data when printing is to be performed without using the electronic sorting function and when printing is to be performed using the single-copy printing function.

According to the above arrangement, when printing is to be performed without using the electronic sorting function and when printing is to be performed using the single-copy printing function, a piece(s) of image data is not stored in the image data storage section. This makes it possible to decrease the frequencies of performing the saving process and the replacement process with respect to the image data storage section.

Further, the printing apparatus may be arranged such that the control section discards, out of pieces of print data of all pages, which print data are received from the external apparatus through the communication section, at the printing of the second or subsequent set of copies during the printing performed using the electronic sorting function, the received print data of a given page whose image data is stored in the image data storage section and is to be used for the printing of that given page.

According to the above arrangement, reception of pieces of print data of all pages eliminates the need for making a request for transmitting print data of a page whose image data is not stored in the image data storage section, which thus simplifies the processes performed in the printing apparatus. In addition, the above arrangement allows the external apparatus to need only to transmit similar data at the printing of a second or subsequent set of copies to those transmitted at the printing of the first set of copies. This eliminates the need for complex control of the external apparatus and enables simplified process of the external apparatus.

Still further, the printing apparatus may be arranged such that the development process section is configured to carry out the development process according to density correction information generated based on output characteristics of the printing process section, and at the printing of the second or subsequent set of copies during the printing performed using the electronic sorting function, the control section determines whether or not calibration for updating the density correction information has been carried out, the control section, if determining that the calibration has been carried out, determines whether the development process needs to be carried out again in accordance with the updated density correction information, and the control section, if determining that the development process needs to be carried out again, causes the development process section to subject print data of a page, which print data is obtained through the communication section, to the development process, regardless of whether image data corresponding to that page is stored in the image data storage section, to generate image data, so that the printing apparatus performs printing based on the generated image data.

According to the above arrangement, in a case where calibration for updating the density correction information is carried out in response to change in output characteristics of the printing process section, the re-development process is carried out in accordance the updated density correction information, so that image data obtained by the re-development process is used for the printing process. This makes it possible to prevent deterioration in print quality at the printing of a second or subsequent set of copies, even when change in output characteristics of the printing process section occurs.

A printing method in accordance with one embodiment of the present invention is a printing method for performing printing using an electronic sorting function for carrying out, when images of multiple pages are to be printed in a plurality of sets of copies, a printing process of printing each set of copies in collated form, the printing method including the steps of: receiving print data from an external apparatus; carrying out a development process of developing the received print data into image data; measuring a time required to complete the development process for each of the pages; carrying out a printing process based on the image data; and storing the image data in an image data storage section, said printing method, at printing of a first set of copies, causing the image data storage section to preferentially store image data of a page that requires a long development time, and at printing of a second or subsequent set of copies, performing the printing process so that printing of a page whose image data is stored in the image data storage section is carried out using that image data, while, for printing of another page whose image data is not stored in the image data storage section, obtaining print data of that page from the external apparatus, and then subjecting the obtained print data to the development process to generate image data, so that the printing process is carried out using the generated image data.

According to the above method, at the printing of a first set of copies, image data of a page that requires a long development time is preferentially stored in the image data storage section, which thus enables efficient printing of a second or subsequent set of copies. This makes it possible to prevent, at the printing of a second or subsequent set of copies, the occurrence of a printing process delay caused by a wait time for the completion of the development process of developing print data into image data, thus enabling a quick printing process.

Note that the printing apparatus may be realized by a computer. In this case, the present invention encompasses: a program for allowing a computer to serve as the printing apparatus by causing the computer to operate as the control section; and a computer-readable storage medium storing the program therein.

The present invention is not limited to the descriptions of the aforementioned embodiment, but can be altered by a person skilled in the art within the scope of the claims. That is, an embodiment obtained by suitable combinations of technical means modified within the scope of the accompanying claims is also encompassed within the technical scope of the present invention.

### INDUSTRIAL APPLICABILITY

The present invention is applicable to a printing apparatus that performs a printing process using an electronic sorting function.

### REFERENCE SIGNS LIST

1 image formation system
10 Information processing apparatus (external apparatus)
11 Control section
12 Display section
13 Operation input section
14 Storage section
15 Communication section
16 Application
17 Printer driver
18 Communication control section
20 Image forming apparatus
21 Control section
22 Operating section
22a Input section
22b Display section
23 Communication section
24 Storage section (image data storage section)
25 Image forming section (printing process section)
25a Recording sheet delivering section
25b Print section
31 Print data analyzing section
32 Print image generating section (development process section)
33 Development time measuring section
34 Saving control section
35 Communication control section
36 Output control section

1. A printing apparatus having an electronic sorting function for carrying out, when images of multiple pages are to be printed in a plurality of sets of copies, a printing process of printing each set of copies in collated form,
the printing apparatus comprising:
a communication section to carry out communication with an external apparatus;
a development process section to carry out a development process of developing print data received by the communication section from the external apparatus into image data,
a printing process section to carry out a printing process based on the image data;
a development time measuring section to measure a time required to complete the development process for each of the pages,
an image data storage section to store the image data therein; and
a control section to control respective operations of the foregoing sections,
in order for said printing apparatus to perform printing using the electronic sorting function, the control section operating at printing of a first set of copies to cause the image data storage section to preferentially store image data of a page that requires a long development time, and
the control section operating at printing of a second or subsequent set of copies to cause the printing process section to perform a printing process so that printing of a page whose image data is stored in the image data storage section is carried out using that image data, while, for printing of another page whose image data is not stored in the image data storage section, the control section causing the communication section to obtain print data of that page from the external apparatus, and then causing the development process section to subject the obtained print data to the development process to generate image data, so that the printing apparatus performs printing based on the generated image data.

2. The printing apparatus according to claim 1, wherein
at the printing of the first set of copies during the printing performed using the electronic sorting function, the control section causes the image data storage section to sequentially store therein pieces of image data of pages, which image data are generated through the development process by the development process section, and, in an event that the image data storage section, as a result, has no enough free space to store image data of a subsequent page, the control section carries out a comparison, in length of time required to complete the development process, between that subsequent page and preceding pages whose image data are previously stored in the image data storage section to find, among the preceding pages whose image data are previously stored in the image data storage section, any page that requires a shorter development time than that subsequent page, and the control section then carries out a replacement process for deleting, from the image data storage section, image data of the page that requires a shorter development time than that subsequent page, and then letting the image data storage section store the image data of the subsequent page therein.

3. The printing apparatus according to claim 1, wherein
at the printing of the second or subsequent set of copies during the printing performed using the electronic sorting function, the control section causes the communication section to transmit, to the external apparatus, a request for transmitting print data of a page whose image data is not stored in the image data storage section.

4. The printing apparatus according to claim 1, wherein
the printing process section includes: a recording sheet delivering section to deliver a recording sheet to be printed; and a print section to print images corresponding to pieces of image data on multiple recording sheets sequentially delivered by the recording sheet delivering section, and
at the printing of the first set of copies during the printing performed using the electronic sorting function, the control section causes the image data storage section to avoid storing therein image data of a given page, out of the pages to be subjected to the printing process, if a length of time required to complete the development process for that given page is shorter than a minimum time interval between sequential deliveries of recording sheets by the recording sheet delivering section.

5. The printing apparatus according to claim 1, wherein
said printing apparatus has a single-copy printing function of printing an image of a single page or images of multiple pages in a single copy or a single set of copies, and
the control section causes the image data storage section to store therein pieces of image data when printing of a plurality of sets of copies is to be performed using the electronic sorting function, while the control section causes the image data storage section to avoid storing a piece(s) of image data when printing is to be performed without using the electronic sorting function and when printing is to be performed using the single-copy printing function.

6. The printing apparatus according to claim 1, wherein
the control section discards, out of pieces of print data of all pages, which print data are received from the external apparatus through the communication section, at the printing of the second or subsequent set of copies during the printing performed using the electronic sorting function, the received print data of a given page whose image data is stored in the image data storage section and is to be used for the printing of that given page.

7. The printing apparatus according to claim 6, wherein
the development process section is configured to carry out the development process according to density correction information generated based on output characteristics of the printing process section, and
at the printing of the second or subsequent set of copies during the printing performed using the electronic sorting function, the control section determines whether or not calibration for updating the density correction information has been carried out, the control section, if determining that the calibration has been carried out, determines whether the development process needs to be carried out again in accordance with the updated density correction information, and the control section, if determining that the development process needs to be carried out again, causes the development process section to subject print data of a page, which print data is obtained through the communication section, to the development process, regardless of whether image data corresponding to that page is stored in the image data storage section, to generate image data, so that the printing apparatus performs printing based on the generated image data.

8. A printing method for performing printing using an electronic sorting function for carrying out, when images of multiple pages are to be printed in a plurality of sets of copies, a printing process of printing each set of copies in collated form,
the printing method comprising the steps of:
receiving print data from an external apparatus;
carrying out a development process of developing the received print data into image data;
measuring a time required to complete the development process for each of the pages;
carrying out a printing process based on the image data; and
storing the image data in an image data storage section,
said printing method, at printing of a first set of copies, causing the image data storage section to preferentially store image data of a page that requires a long development time, and
at printing of a second or subsequent set of copies, performing the printing process so that printing of a page whose image data is stored in the image data storage section is carried out using that image data, while, for printing of another page whose image data is not stored in the image data storage section, obtaining print data of that page from the external apparatus, and then subjecting the obtained print data to the development process to generate image data, so that the printing process is carried out using the generated image data.

9. (canceled)

10. A non-transitory computer-readable storage medium storing therein a program for causing a computer to operate as the printing apparatus according to claim 1, the program causing the computer to function as the control section of the printing apparatus.
